(19) United States
(12) Patent Application Publication
(10) Pub. No.: US 2007/0214902 A1
(43) Pub. Date: Sep. 20, 2007

(54) Nut structure for linear transmission device

(75) Inventor: Chia-Jung Wang, Xindian City (TW)

Correspondence Address: HDSL, 4331 STEVENS BATTLE LANE, FAIRFAX, VA, 22033, US

(73) Assignee: T-MOTION Technology Co Ltd.

(21) Appl. No.: 11/377,442

(22) Filed: Mar. 17, 2006

(51) Int. Cl. F16H 25/20

(52) U.S. Cl. 74/89.26

(57) ABSTRACT

A nut structure is used for being screwed to a guiding screw and includes a main nut, a safety nut, a resilient body and a position-restricting piece. The main nut is made of plastic material and provided in its interior with inner threads and an accommodating chamber formed on one side of the inner threads. The safety nut and the resilient body are provided in the accommodating chamber. The safety nut also has inner threads and is axially displaceable with respect to the main nut. Both ends of the resilient body abut on the corresponding end faces of the main nut and the safety nut, respectively. Further, a position-restricting piece is fixed to one side of the accommodating chamber of the main nut for restricting the range of the displacement of the safety nut in the accommodating chamber. With this structure, a sufficient safety can be assured even when the wear occurs between the main nut and the guiding screw.

### BACKGROUND OF THE INVENTION

1. Field of the Invention

The present invention relates to a nut structure for a linear transmission device, and in particular to a safety nut mounted on the linear transmission device.

2. Description of Prior Art

The linear transmission device utilizes driving components such as a motor and a combination of worm screws and worm wheels to drive a guiding screw to rotate, thereby a telescopic tube fixed on the guiding screw can be also driven to linearly extend and retract. Therefore, the linear transmission device is widely used in the elevating means of a sickbed or other fields in which the extension and retraction are to be carried out. The guiding screw of a common linear transmission device is screwed to a nut with its outer threads. One end of the nut is fixed to a telescopic tube. However, in order to reduce the frictional noise and the coefficient of friction between the guiding screw and the nut, the nut is made of plastic material. Since the guiding screw is made of metallic material, the nut will wear under a long-term transmission engagement. As a result, the nut cannot bear the original load, and in turn the linear transmission device cannot continuously operate. Even, the nut probably cannot bear the load, so that the telescopic tube instantaneously falls down to cause accidents.

For example, a conventional nut structure for the linear transmission device is disclosed in EP 0586326. The linear transmission device has a guiding screw, a nut structure linearly displaceable along the axial direction of the guiding screw and a telescopic tube fixed to the nut structure. The nut structure comprises a main nut, a safety nut provided on one side of the main nut and a gasket clamped between the end faces of the main nut and the safety nut. A recessed hole and a through hole are provided on a side face of the main nut and the safety nut, respectively. Further, on the contacting surfaces of the gasket with the main nut and the safety nut, a positioning pillar is provided, respectively. Accordingly, a safety mechanism for a nut of the linear transmission device is achieved.

However, in use, the conventional nut structure for the linear transmission device still has some problems as follows. Since the safety nut abuts against the gasket and the main nut and the pitch of the inner threads of the safety nut is the same as that of the main nut, the wear of the inner threads of the main nut may cause an increasing gap between the outer threads of the guiding screw and the inner threads of the main nut. But, the inner threads of the safety nut are not liable to get worn, causing the jam between the guiding screw and the nut structure during the transmission. Further, the positioning pillar provided on the gasket is made to disengage from the gasket or the main nut under the long-term shear force. As a result, the nut structure completely losses its effect of protecting.

Therefore, in view of the above the drawbacks, the inventor proposes the present invention to overcome the above problems based on his expert experiences and deliberate researches.

### SUMMARY OF THE INVENTION

The present invention is to provide a nut structure for a linear transmission device, in which a safety nut is used to bear the load of the main nut, so that a sufficient safety can be assured even when the wear occurs between the main nut and the guiding screw.

The present invention provides a nut structure for a linear transmission device. The linear transmission device has a guiding rod and a nut structure linearly displaceable along the axial direction of the guiding screw. The nut structure comprises a main nut, a safety nut, a resilient body and a position-restricting piece. The main nut is made of plastic material and provided in its interior with inner threads screwed to the guiding screw and an accommodating chamber formed on one side of the inner threads. The safety nut and the resilient body are provided in the accommodating chamber. The safety nut also has inner threads screwed to the guiding screw and is axially displace with respect to the main nut. Both ends of the resilient body abut on the corresponding end faces of the main nut and the safety nut, respectively. Further, a position-restricting piece is fixed to one side of the accommodating chamber of the main nut for restricting the range of the displacement of the safety nut in the accommodating chamber.

In order to achieve the above object, the present invention provides to a nut structure for being screwed to a guiding screw. The nut structure comprises a main nut, a safety nut, a resilient body and a position-restricting piece. The main nut is made of plastic materials and provided in its interior with inner threads and an accommodating chamber formed on one side of the inner threads. The safety nut and the resilient body are provided in the accommodating chamber. The safety nut also has inner threads and is axially displace with respect to the main nut. Both ends of the resilient body abut on the corresponding end faces of the main nut and the safety nut, respectively. Further, a position-restricting piece is fixed to one side of the accommodating chamber of the main nut for restricting the range of the displacement of the safety nut in the accommodating chamber.

### BRIEF DESCRIPTION OF THE DRAWINGS

FIG. 1 is an exploded perspective view of the present invention;

FIG. 2 is a schematic view showing the assembling of the present invention;

FIG. 3 is a cross-sectional view showing the assembling of the present invention;

FIG. 4 is a cross-sectional view showing the assembled state in which the present invention is applied to a linear transmission device;

FIG. 5 is a view showing the state in which the present invention and the guiding screw are in use.

### DETAILED DESCRIPTION OF THE INVENTION

The detailed description and the technical contents of the present invention will be explained with reference to the accompanying drawings. However, it should be understood that the drawings are illustrative but not used to limit the scope of the present invention.

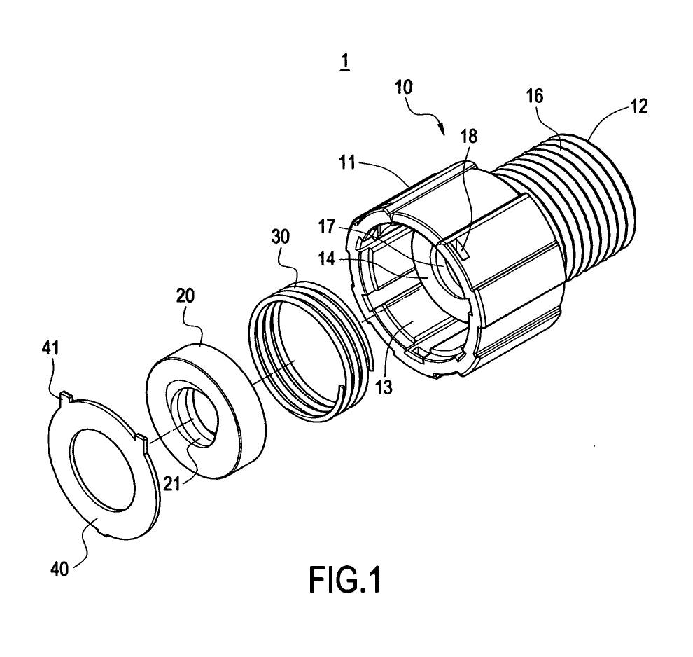

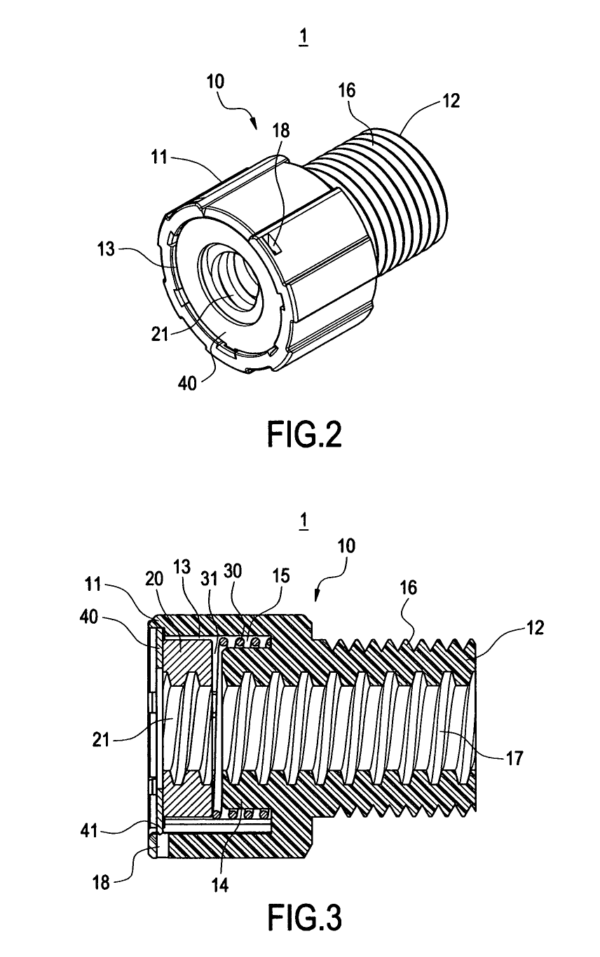

FIG. 1 is an exploded perspective view of the present invention. FIG. 2 is a schematic view showing the assembling of the present invention. FIG. 3 is a cross-sectional view showing the assembling of the present invention. The present invention is to provide a nut structure for a linear transmission device. The nut structure 1 comprises a main nut 10, a safety nut 20, a resilient body 30 and a position-restricting plate 40.

The main nut 10 is made of plastic material and has a cylindrical body 11 and a protrusion 12 extending outwardly from one end of the cylindrical body 11. Within the cylindrical body, an accommodating chamber 13 is formed. Further, a positioning shaft 14 extends outwardly from one side of the accommodating chamber 13 adjacent to the protrusion 12. An annular groove 15 is formed between the outer peripheral surface of the positioning shaft 14 and the inner wall face of the cylindrical body 11. The outer peripheral surface of the protrusion 12 is formed with outer threads 16, and the inner surface thereof is formed with inner threads 17 penetrating the positioning shaft 14. Also, a plurality of insertion slots 18 is provided on the outer surface of the accommodating chamber 13 and on the cylindrical body 11.

The safety nut 20 can be made of metallic materials and arranged in the accommodating chamber 13 of the main nut 10. The safety nut 20 is axially displaceable with respect to the main nut 10. The center of the safety nut 20 also has inner threads 21.

The resilient body 30 may be a spiral spring and also provided in the accommodating chamber 13 of the main nut 10. The resilient body 30 is connected to the outside of the positioning shaft 14 and received in the groove 15. Both ends of the resilient body 30 abut on the corresponding end faces of the main nut 10 and the safety nut 20, respectively. A gap 31 is formed between the end faces of the safety nut 20 and the positioning shaft 14 to avoid the wear between the inner threads 17 of the main nut 10 and the inner threads 21 of the safety nut 20. As a result, the jam between these two components can be efficiently prevented.

The position-restricting piece 40 may be an annular plate. A plurality of positioning blocks 41 extends outwardly from the periphery of the annular plate. Each of the positioning blocks 41 corresponds to and cooperates with the insertion slot 18 of the main but 10, so that the range of the displacement of the safety nut 20 in the accommodating chamber 13 of the main nut 10 can be restricted.

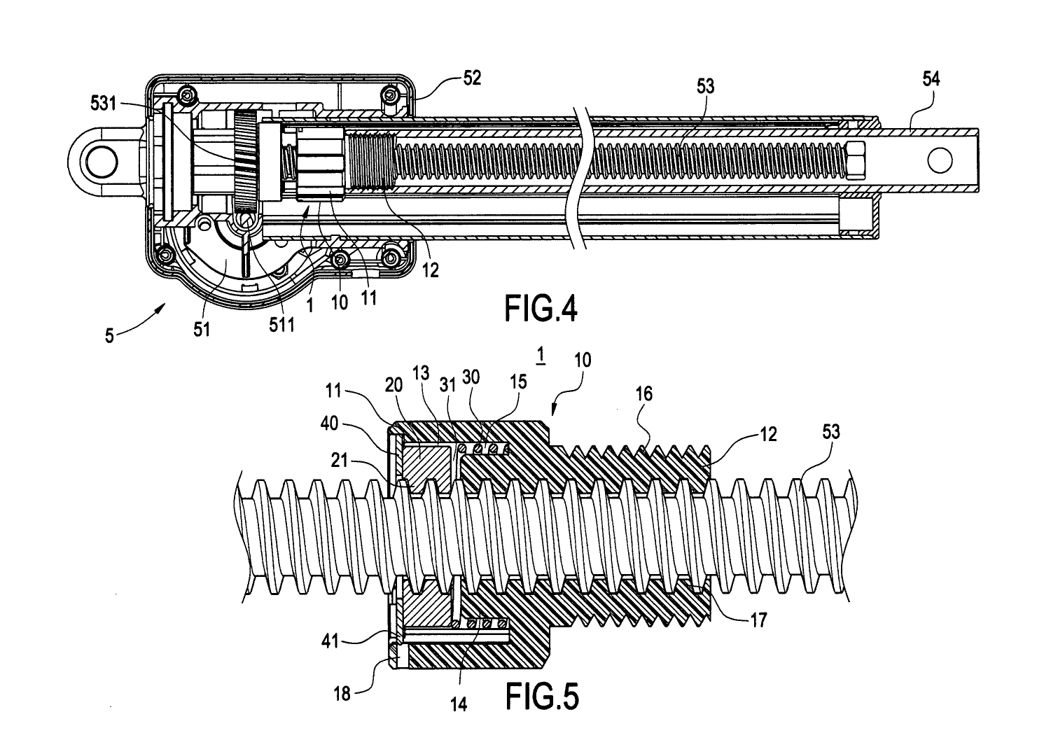

FIG. 4 is a cross-sectional view showing the assembled state in which the present invention is applied to a linear transmission device, and FIG. 5 is a view showing the state in which the present invention and the guiding screw are in use. The nut structure 1 of the present invention can be applied to a linear transmission device 5. The linear transmission device 5 comprises a motor 51, a fixing base 52, a guiding screw 53 and a telescopic tube 54. The motor 51 is fixed to the bottom of the fixing base 52. The shaft center of the motor 51 is connected to a worm screw 511 extending into the fixing base 52. Within the fixing base 52 and along the direction perpendicular to the worm screw 511, a guiding screw 53 made of metallic material is provided. One end of the guiding screw 53 is fixed to a worm wheel 531 in transmission engagement with the worm screw 511. The nut structure 1 of the present is screwed on the guiding screw 53 and linearly displaceable along the axial direction of the guiding screw 53. Further, the outer threads 16 of the main nut 10 are screwed to one end of the telescopic tube 54.

In use, the motor 51 drives the worm screw 511 to rotate, thereby to drive the worm wheel 531 and the guiding screw 53 fixed to the worm wheel 531 to rotate. After the guiding screw 53 starts to rotate, the rotation can be transmitted to the main nut 10 and the safety nut 20 of the nut structure 1 and makes the telescopic tube 54 to extend or retract with respect to the fixing base 52. During the transmission engagement of the guiding screw 53 with the main nut 10 and the safety nut 20, since both end faces of the resilient body 30 abut on the corresponding end faces of the main screw 10 and the safety nut 20, respectively, the relative angle or position between the safety nut 20 and the guiding screw 53 can be automatically adjusted by the frictional damping produced between the resilient body 30 and the end faces of the main nut 10 and safety nut 20. As a result, the jam between these two components will not occur even when the inner threads 17 of the main nut 10 have worn.

According to the above, the nut structure for the linear transmission device of the present invent indeed has industrial applicability, novelty and inventive steps. Further, since the construction of the present invention has not been published or put to public use prior to applying for patent, and thus conforms to the requirements for a utility model patent.

Although the present invention has been described with reference to the foregoing preferred embodiments, it will be understood that the invention is not limited to the details thereof Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A nut structure for a linear transmission device, the linear transmission device having a guiding rod and the nut structure linearly displaceable along the axial direction of the guiding screw, the nut structure comprising:
a main nut made of plastic material and provided in its interior with inner threads screwed to the guiding screw and an accommodating chamber formed on one side of the inner threads;
a safety nut provided in the accommodating chamber of the main nut and also having inner threads screwed to the guiding screw, the safety nut being axially displaceable with respect to the main nut;
a resilient body provided in the accommodating chamber of the main nut, both ends of the resilient body abutting on the corresponding end faces of the main nut and the safety nut, respectively, and
a position-restricting piece fixed to one side of the accommodating chamber of the main nut for restricting the range of the displacement of the safety nut in the accommodating chamber.

2. The nut structure for a linear transmission device according to claim 1, wherein the main nut has a cylindrical body and a protrusion extending outwardly from one end of the cylindrical body, and the accommodating chamber is formed within the cylindrical body.

3. The nut structure for a linear transmission device according to claim 2, wherein a positioning shaft extends outwardly from one side of the accommodating chamber adjacent to the protrusion, a groove is formed between the outer peripheral surface of the positioning shaft and the inner wall face of the cylindrical body, and the positioning shaft and the groove are adapted to connect to and receive the resilient body.

4. The nut structure for a linear transmission device according to claim 3, wherein a gap is formed between the corresponding end faces of the positioning shaft and the safety nut.

5. The nut structure for a linear transmission device according to claim 2, wherein a plurality of insertion slots is provided on the outer surface of the accommodating chamber and on the cylindrical body, the position-restricting piece is an annular plate, and a plurality of positioning blocks extend outwardly from the periphery of the annular plate for being correspondingly inserted into the insertion slots.

6. The nut structure for a linear transmission device according to claim 1, wherein the safety nut is made of metallic materials.

7. The nut structure for a linear transmission device according to claim 1, wherein the resilient body is a spiral spring.

8. A nut structure, comprising:
a main nut made of plastic material and provided in its interior with inner threads and an accommodating chamber formed on one side of the inner threads;
a safety nut provided in the accommodating chamber of the main nut and also having inner threads, the safety nut being axially displaceable with respect to the main nut;
a resilient body provided in the accommodating chamber of the main nut, both ends of the resilient body abutting on the corresponding end faces of the main nut and the safety nut, respectively, and
a position-restricting piece fixed to one side of the accommodating chamber of the main nut for restricting the range of the displacement of the safety nut in the accommodating chamber.

9. The nut structure according to claim 8, wherein the main nut has a cylindrical body and a protrusion extending outwardly from one end of the cylindrical body, and the accommodating chamber is formed within the cylindrical body.

10. The nut structure according to claim 9, wherein a positioning shaft extends outwardly from one side of the accommodating chamber adjacent to the protrusion, a groove is formed between the outer peripheral surface of the positioning shaft and the inner wall face of the cylindrical body, and the positioning shaft and the groove are adapted to connect to and receive the resilient body.

11. The nut structure according to claim 10, wherein a gap is formed between the corresponding end faces of the positioning shaft and the safety nut.

12. The nut structure according to claim 9, wherein a plurality of insertion slots is provided on the outer surface of the accommodating chamber and on the cylindrical body, the position-restricting piece is an annular plate, and a plurality of positioning blocks extend outwardly from the periphery of the annular plate for being correspondingly inserted into the insertion slots.

13. The nut structure according to claim 8, wherein the safety nut is made of metallic materials.

14. The nut structure according to claim 8, wherein the resilient body is a spiral spring.
